(19) United States
(12) Patent Application Publication
(10) Pub. No.: US 2006/0262497 A1
(43) Pub. Date: Nov. 23, 2006

(54) Apparatus to hold laptop or notebook computer vertically while connected to a full size keyboard, mouse and external monitor

(76) Inventor: Victor Jahlokov, Charlotte, NC (US)

Correspondence Address: Donald W. Meeker;Patent Agent, 924 East Occan Front, #E, Newport Beach, CA, 92661, US

(21) Appl. No.: 11/439,013

(22) Filed: May 23, 2006

Related U.S. Application Data
(60) Provisional application No. 60/594,965, filed on May 23, 2005.

(51) Int. Cl. G06F 1/16

(52) U.S. Cl. 361/683

(57) ABSTRACT

An apparatus to support a laptop computer so that it can stand on its edge/spine, thereby supporting the laptop in a vertical orientation so that the laptops footprint on the desktop is reduced. While the apparatus supports the laptop vertically its built-in screen is in the closed position. However, the user is still able to operate the laptop without the use of an electronic docking station simply by connecting directly to the laptop a full size keyboard, mouse and external monitor. An adjustable cradle accommodates laptops of various thicknesses.

### CROSS-REFERENCE TO RELATED APPLICATIONS

This application claims the benefit of U.S. Provisional Patent Application No. 60/594,965, filed on May 23, 2005.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to computer accessories and in particular to a simple support system to maintain a portable computer, such as a laptop or notebook, in a vertical position on a desk to occupy a minimal amount of space on the desk while the portable computer is connected to a full size monitor, keyboard, and mouse on the desk.

2. Description of Related Art Including Information Disclosed Under 37 CFR 1.97 and 1.98

When portable computing devices such as laptops are used for extended periods of time in a home or office environment, the features that make them portable, i.e. their small dimensions, limit long term comfort during use. As a result, they are not as convenient as larger desktop computers when operated for longer periods of time. Both the smaller viewing area of the laptops built-in screen as well as the smaller dimensions of the built-in keyboard make long term use inconvenient as compared to desktops. Additionally, the smaller keyboard not only hampers typing but also has fewer keys than a full size keyboard normally used in conjunction with a desktop computer, which results in less overall functionality. Consequently, the user may prefer to connect a larger external monitor and a full size external keyboard and mouse to make long-term use more convenient. In essence, arrange the laptop on his/her desk so that it is more stationary, i.e. have the laptop mimic a desktop workstation when it is not necessary to transport the laptop for extended periods of time.

One of the technologies currently available to satisfy the users need to temporarily dock laptops and use a full size keyboard, mouse and larger monitor in conjunction with the laptop are electronic docking stations [Ref. 1-28]. Electronic docking stations are complicated to manufacture since they require built-in electronics (e.g. port replicators) that are necessary to bridge the connection between the laptop and the external peripheral input and output devices. Additionally, a docking station must be designed specifically for a particular laptop brand and model as a result of the docking stations input ports having to match the exact location or configuration of a specific laptop models output ports so that the laptop can be mated with the docking station. As a result of these complexities, satisfactory economies of scale in production cannot be realized. This results in higher manufacturing prices and subsequently higher prices being passed along to consumers. Furthermore, docking stations do not reduce the footprint of the laptop on the user's desktop, and in some cases may increase the footprint when the laptop is used in conjunction with an electronic docking station. Finally, miniaturization of electronic docking stations is limited by the necessity of using built-in electronics.

Another technology available to users involves using a stand that holds an open laptop upright on the front edge of the base that contains the built-in keyboard [Ref. 29-35]. The main disadvantage of these devices is their relatively large size and large footprint on the user's desk. When such a stand is used the resulting footprint is larger than the footprint that is achieved by the invention and the various embodiments described herein.

Current technology allows portable laptop computers to be operated while their built-in displays are closed and they are either directly hardwired or connected wirelessly (e.g. using Bluetooth technology) to a full size keyboard, mouse and connected to an external monitor. Additionally, electronic docking stations are no longer a necessity since it is possible to connect larger external monitors and full-size keyboard and mouse input devices directly to the laptop through the use of the laptops DVI and USB connections or wirelessly using technologies such as Bluetooth. Currently, no inventions relate to the use of devices that can hold the laptop vertically while the laptops internal display is closed and the computer is operated while directly connected to peripheral devices without the use of an electronic docking station.

### PRIOR ART PATENT REFERENCES WITH PATENT NUMBER, ISSUE MONTH AND YEAR, INVENTOR, AND CLASS/SUBCLASS

| | | |
|---|---|---|
| (1) 5,030,128 | July 1991 Herron et al. | 439/372 |
| (2) 5,126,954 | June 1992 Morita | 364/708 |
| (3) 5,175,671 | December 1992 Sasaki | 361/392 |
| (4) 5,182,698 | January 1993 Kobayashi et al. | 361/395 |
| (5) 5,283,714 | February 1994 Tsai et al. | 361/683 |
| (6) 5,290,178 | March 1994 Ma | 439/652 |
| (7) 5,347,425 | September 1994 Herron et al. | 361/683 |
| (8) 5,452,180 | September 1995 Register et al. | 361/686 |
| (9) 5,459,637 | October 1995 Ma et al. | 361/686 |
| (10) 5,488,572 | January 1996 Belmont | 364/514 |
| (11) 5,526,493 | June 1996 Shu | 395/281 |
| (12) 5,633,782 | May 1997 Goodman et al. | 361/683 |
| (13) 5,805,412 | September 1998 Yanagisawa et al. | 361/686 |
| (14) 5,926,627 | July 1999 Sugimura | 395/281 |
| (15) 6,309,230 | October 2001 Helot | 439/131 |
| (16) 5,768,101 | June 1998 Cheng | 361/687 |
| (17) 5,187,645 | February 1993 Spalding et al. | 361/393 |
| (18) 5,436,792 | July 1995 Leman et al. | 361/686 |
| (19) 5,579,528 | November 1996 Register | 395/671 |
| (20) 5,687,060 | November 1997 Ruch et al. | 361/686 |
| (21) 5,822,185 | October 1998 Cavello | 361/686 |
| (22) 6,091,602 | July 2000 Helot | 361/686 |
| (23) 6,185,096 | February 2001 Helot et al. | 361/686 |
| (24) 6,208,508 | March 2001 Ruch et al. | 361/686 |
| (25) 6,256,193 | July 2001 Janik et al. | 361/683 |
| (26) 6,583,984 | June 2003 Yin et al. | 361/686 |
| (27) 6,590,767 | July 2003 Liao et al. | 361/686 |
| (28) 6,765,792 | July 2004 Yin et al. | 361/686 |
| (29) 5,503,361 | April 1996 Kan-O et al. | 248/688 |
| (30) 5,607,135 | March 1997 Yamada | 248/456 |
| (31) 5,899,421 | May 1999 Silverman | 248/175 |
| (32) 5,915,661 | June 1999 Silverman et al. | 248/465.1 |
| (33) 6,352,233 | March 2002 Barberich | 248/676 |
| (34) 6,545,864 | April 2003 Davis, IV | 361/683 |
| (35) 6,819,548 | November 2004 Hillis et al. | 361/681 |
| (36) 5,552,960 | September 1996 Nelson et al. | 361/687 |

What is needed is a device that can hold the laptop vertically while the laptops internal display is closed and the computer is operated while directly connected to peripheral devices without the use of an electronic docking station provided as an inexpensive alternative to laptop users who do not wish to buy expensive electronic docking stations or do not wish to use the large stands currently available in the marketplace.

### BRIEF SUMMARY OF THE INVENTION

An object of the present invention is to provide a device that can hold the laptop vertically while the laptops internal display is closed and the computer is operated while directly connected to peripheral devices without the use of an electronic docking station provided as an inexpensive alternative to laptop users who do not wish to buy expensive electronic docking stations or do not wish to use the large stands currently available in the marketplace.

In brief, the present invention relates to a device or devices used to support a laptop computer vertically on a user's desk with the objective of reducing the laptops footprint on the users work area, benefiting the user by increasing his/her usable desk space. The invention works similarly to a bookstand. It is basically a device that enables the laptop to be supported in a vertical orientation when the user wishes the laptop to stand on its edge or spine to decrease the laptops footprint on the desk. In one embodiment of the invention either two or more devices or in another embodiment, one larger device is placed on the desk and the laptop is cradled within it and thereby vertically supported. While cradled within the device, the laptops internal display is closed and the user connects directly to the laptop a full size keyboard, mouse and monitor to operate it and positions them in such a way as to maximize his/her ergonomic comfort.

In addition to the reduction in footprint on the desk, other important advantages of the disclosed invention over existing electronic docking station technology stem from its simple design, which increases manufacturability and lowers manufacturing costs. Additionally, the embodiments take advantage of the laptops built-in peripheral device support; therefore, electronics do not need to be built-in to the devices to use the laptop with more convenient full size user input devices (keyboard and mouse) and larger monitors.

Advantages over existing stand designs relate to the inventions smaller, more compact design. The laptops footprint on the user's desk is smaller when the present invention described herein is used as compared to using stands. The small dimensions of the invention also make it more portable to transport for the user and cheaper and easier to ship and store for retail purposes in comparison to both stands and electronic docking stations.

Since the invention allows the laptop to be oriented vertically, an additional advantage is that cooling is enhanced since the underside of the laptop is exposed to more airflow, extending the laptops useful life. Also, the devices with various embodiments described herein can be made from a variety of materials relatively quickly, easily and inexpensively in comparison to current technologies mentioned. An adjustable cradle accommodates laptops of various thicknesses.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1a is a perspective view of the preferred embodiment of the invention that requires using a minimum of two brackets each with two spaced vertical supports interconnected by a base support to support a portable computer vertically by positioning the devices along the width of the portable computer's edge/spine at such a distance as to allow adequate support of the portable computer;

FIG. 1b is a perspective view of the two brackets of FIG. 1 supporting a portable computer with a pair of dowels interconnecting the two brackets;

FIG. 2a is a perspective view of an alternate embodiment of the present invention with a single wider bracket having two vertical spaced support walls interconnected by a support base positioned in the middle of a portable computer held vertically in the device;

FIG. 2b View A is a side elevational view of the invention of FIG. 2a further comprising a fan built into one of the support walls with the fan plugged into a USB port of the portable computer supported vertically by the device;

FIG. 2b View B is an end elevational view of the invention of FIG. 2b View A;

FIG. 2c is a perspective view of the invention of FIG. 2a having cooling ridges structured into at least one of the pair of spaced support walls;

FIG. 3 is a perspective view of an alternate embodiment of the invention having a pair of end supports to maintain the portable computer in a vertical position with at least one of the end supports has an opening to admit cables to the ports in the side edge of the portable computer;

FIG. 4a View A is a perspective view of an embodiment of the invention which envelopes the portable computer showing an end opening for sliding the portable computer into the support;

FIG. 4a View B is a perspective view of the embodiment of the invention of FIG. 4a View A showing an opening in the opposite end of the device for access the CD ROM opening in the opposite edge of the portable computer;

FIG. 4b is a perspective view of the embodiment of the invention of FIG. 4a further comprising a fan built into at least one of the vertical support walls;

FIG. 4c View A is a perspective view of the embodiment of the invention of FIG. 4a having cooling ridges structured into one of the vertical support walls;

FIG. 4c View B is a perspective view of the embodiment of the invention of FIG. 4c View A having cooling ridges structured into the other of the vertical support walls;

FIG. 5 is a perspective view of an alternate embodiment of the invention having a single end support to maintain the portable computer in a vertical position with the end wall having an opening to admit cables to the ports in the side edge of the portable computer;

FIG. 6 is a perspective view of an alternate embodiment of the invention having a support base with a tapered recessed track in the top surface and two vertical supports each having mating tapered bottoms to slide in the track to adjust the vertical supports to retain portable computers of a variety of thicknesses.

### DETAILED DESCRIPTION OF THE INVENTION

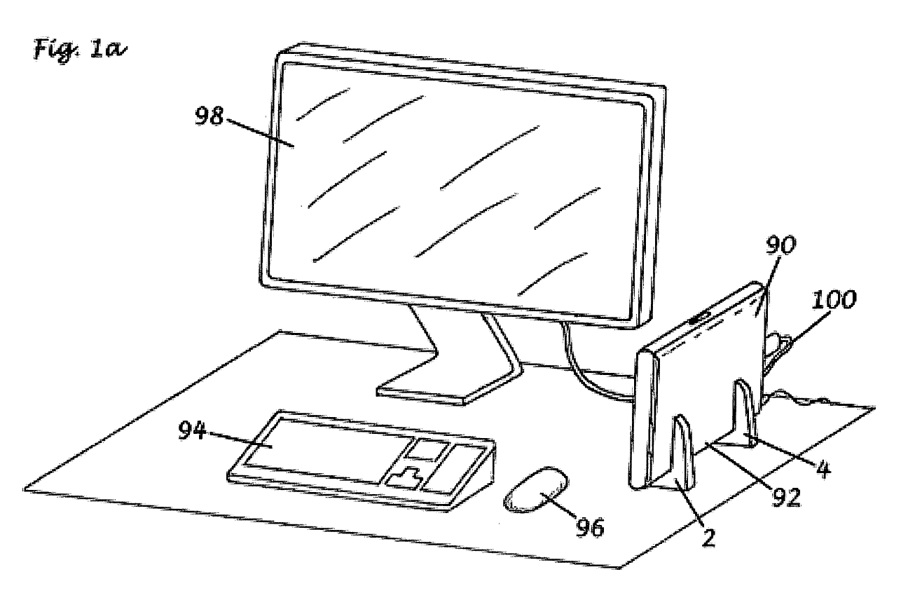

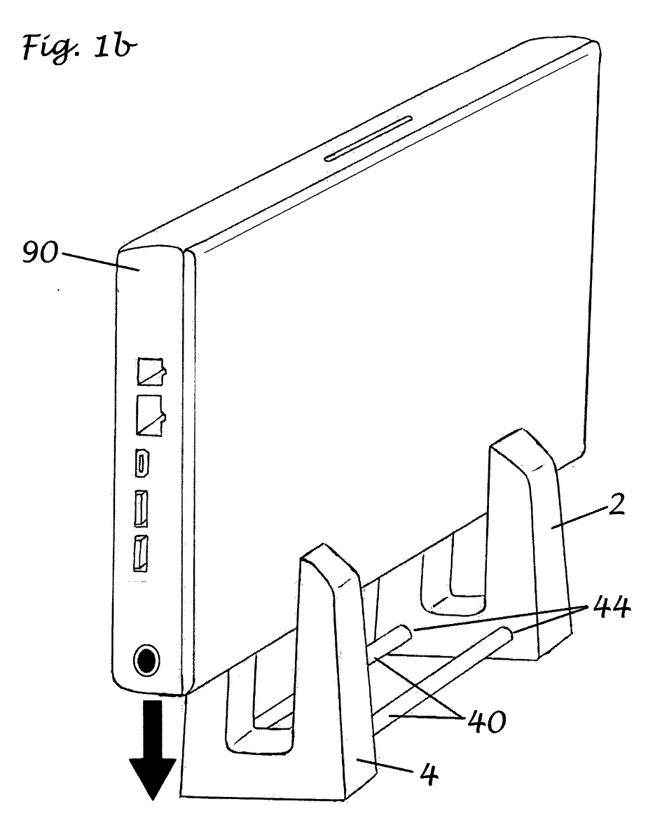

In FIGS. 1-6, the current invention comprises an inexpensive space saving support to maintain a portable computer in an upright position with wired or transmitted connections between a full-sized monitor, full-sized keyboard, and mouse and the portable computer as an alternative to portable computer users who do not wish to buy expensive electronic docking stations or do not wish to use the large stands currently available in the marketplace.

FIG. 1a offers a perspective of the preferred embodiment of the invention that requires using a minimum of two devices (2 and 4), that support a laptop (90) by positioning the devices (2 and 4) along the width of the laptop's edge/spine (92) at such a distance as to allow adequate support of the laptop when it is positioned vertically to achieve the goal of reducing the laptops (90) footprint on the desk. While the closed laptop is cradled within the devices (2 and 4), a peripheral full size keyboard (94), mouse (96) and monitor (98) can be connected directly to the laptop by hardwiring (100) or using wireless technology such as Bluetooth.

FIG. 1b offers a perspective of a variation of the embodiment shown in FIG. 1a showing that the devices (2 and 4) can be connected together using a minimum of two or more rods (40) to provide stability to the devices (2 and 4). The laptop (90) is lowered into the assembled device as shown in FIG. 1b, and a reduced footprint on the desk is achieved.

For cost, ease and speed of manufacturability, the preferred material to fabricate the device(s) depicted in FIGS. 1a and 1b are either clear acrylic plate or aluminum plate. The preferred manufacturing sequences to create the device(s) shown in FIGS. 1a and 1b are to first to cut acrylic or aluminum plate material into blanks by either conventional band saw machining, EDM, or water jet cutting. Then, the device(s) must be Computerized Numerical Control (CNC) machined to achieve the dimension tolerances that are desired. If one desires to include the support rods (40) as shown in FIG. 1b, holes must be drilled or CNC machined into the device(s) near the general location depicted in FIG. 1b (44). Next, the device(s) must be polished to develop a smooth surface finish and to remove any machining marks. To fabricate the support rods (40), pre-manufactured clear acrylic or aluminum rods can be purchased and cut to the necessary lengths. Gluing the rods into the pre-machined holes results in the assembled device shown in FIG. 1b.

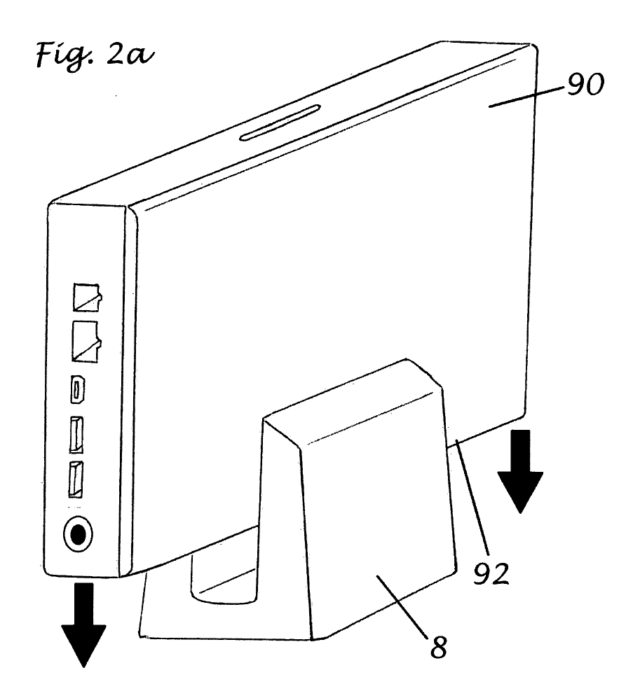

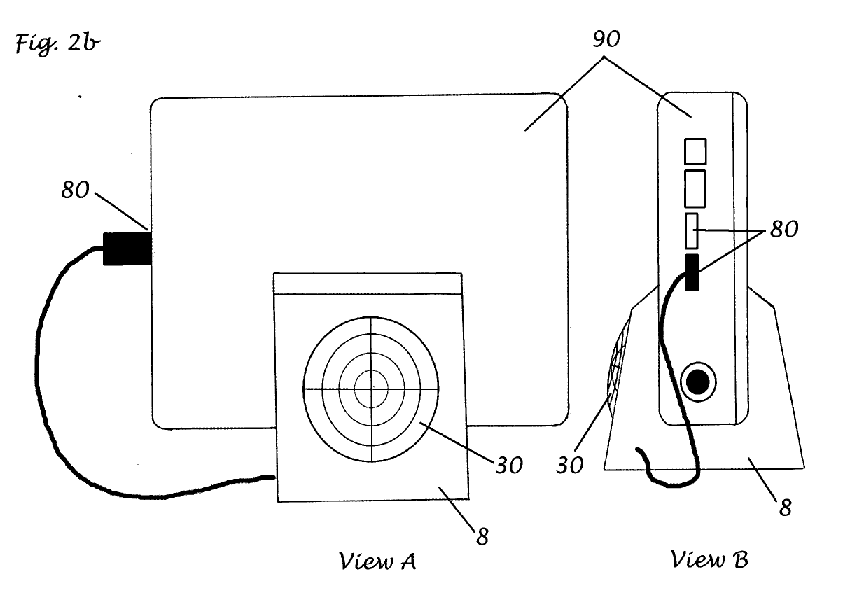

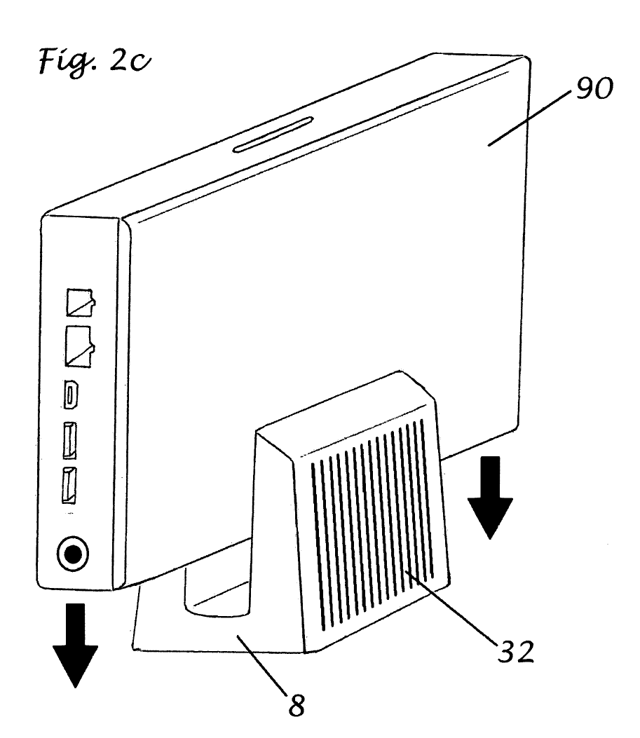

FIG. 2a offers a perspective of a variation of the embodiment shown in FIG. 1a where it is also possible to manufacture one device (8) that is longer/larger than devices (2 and 4) that are shown in FIG. 1a to support more of the edge/spine surface area (92) of the laptop (90). The device (8) can be positioned at the center of the laptop's spine/edge (92) to achieve the same objective of allowing the laptop (90) to be positioned vertically, thereby reducing the laptops footprint on the desk.

FIG. 2b offers a perspective of a variation of the embodiment shown in FIG. 2a where additional cooling can be provided to the laptop (90) by installing a fan (30) within the device (8) that can be powered by the laptops internal USB port (80), alkaline or rechargeable batteries, or external power such as an AC Adapter or standard electrical plug.

FIG. 2c offers a perspective of a variation of the embodiment shown in FIG. 2a where additional cooling can be provided to the laptop (90) by increasing the cooling efficiency of the device (8) by machining cooling ridges (32) along the outer walls of the device which increases the amount of the devices surface area that is exposed to air.

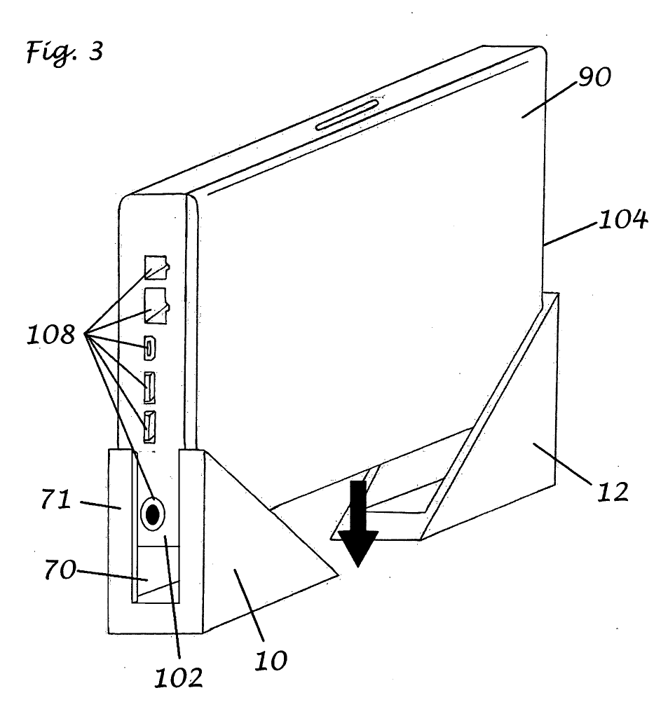

FIG. 3 offers a perspective of a variation of the embodiment shown in FIG. 1a where two devices (10 and 12) are manufactured to support the opposing sides/corners of the laptop (102 and 104) to orient and support the laptop in the vertical orientation and thereby reduce its footprint on the desk. One of two of the devices (10) must have an opening (70) along one vertical edge (71) so that the laptops (90) power and interface ports (108) can be accessed.

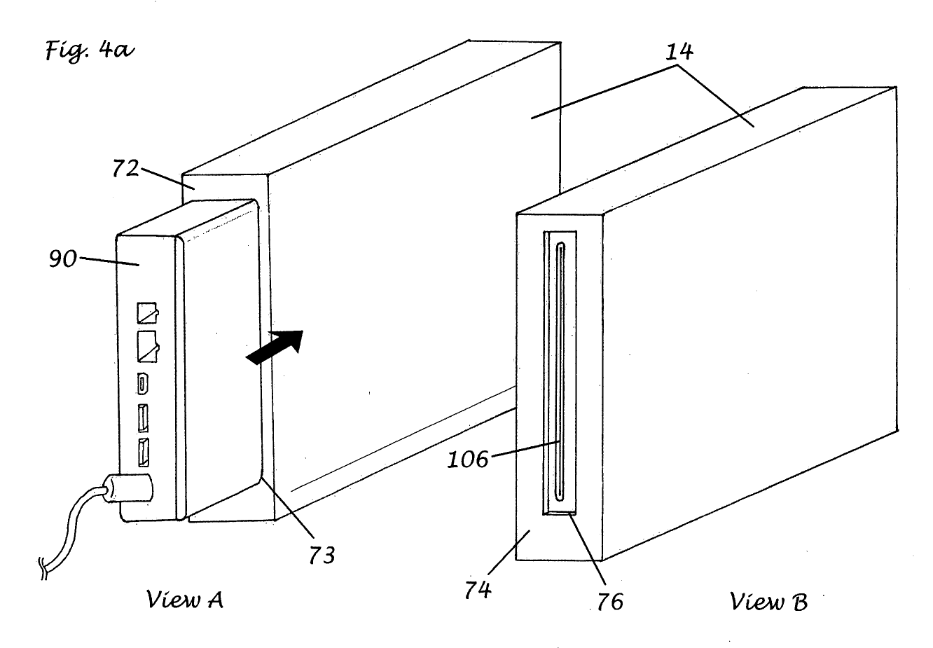

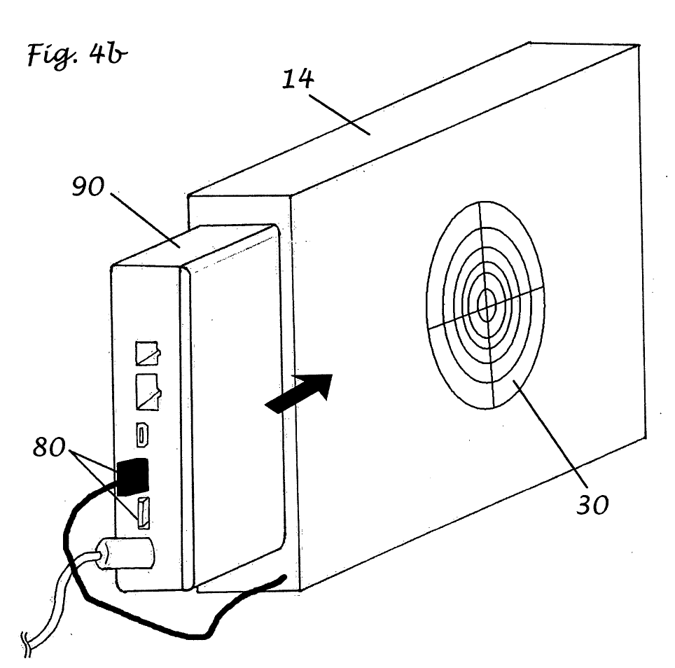

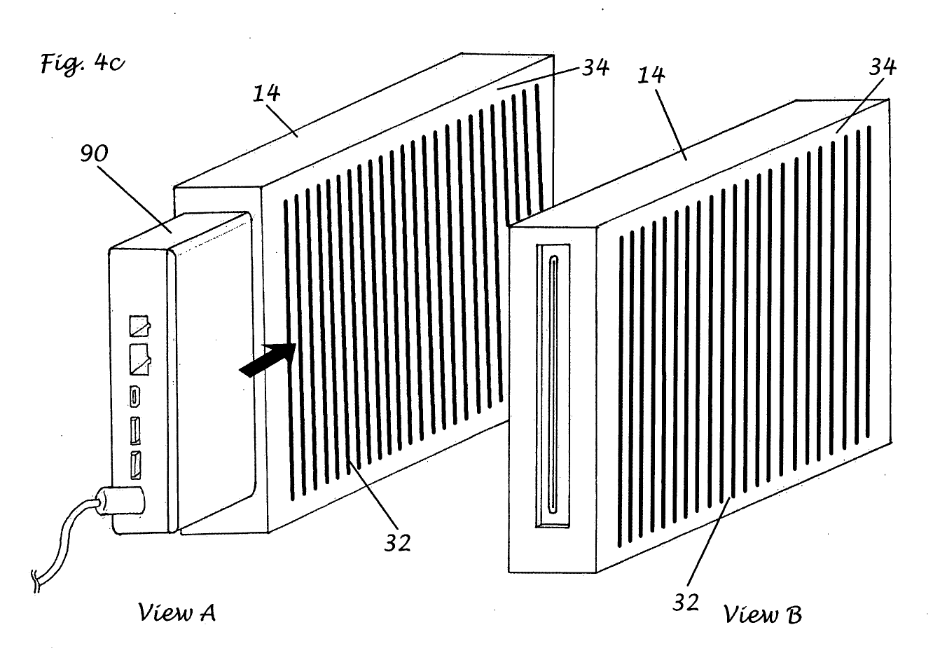

FIG. 4a offers a perspective of a variation of the embodiment shown in FIG. 1a where one device (14) can be fabricated that envelopes/encases the entire laptop (90) to support the laptop in the vertical orientation and reduce its footprint on the desk. One side of the device (72) must be open (73) so that the laptop can be slid into the casing while the opposing side (74) must have an opening (76) so that the laptops (90) built-in CD-ROM device (106) can be accessed.

FIG. 4b offers a perspective of a variation of the embodiment shown in FIG. 4a where additional cooling can be provided to the laptop (90) by installing a fan (30) within the device (14) that can be powered by the laptops internal USB port (80), alkaline or rechargeable batteries, or external power such as an AC Adapter or standard electrical plug.

FIG. 4c offers a perspective of a variation of the embodiment shown in FIG. 4a where additional cooling can be provided to the laptop (90) by fabricating cooling ridges (32) along the outer walls (34) of the device (14) to increase the devices cooling efficiency by increasing the amount of the devices surface area that is exposed to air.

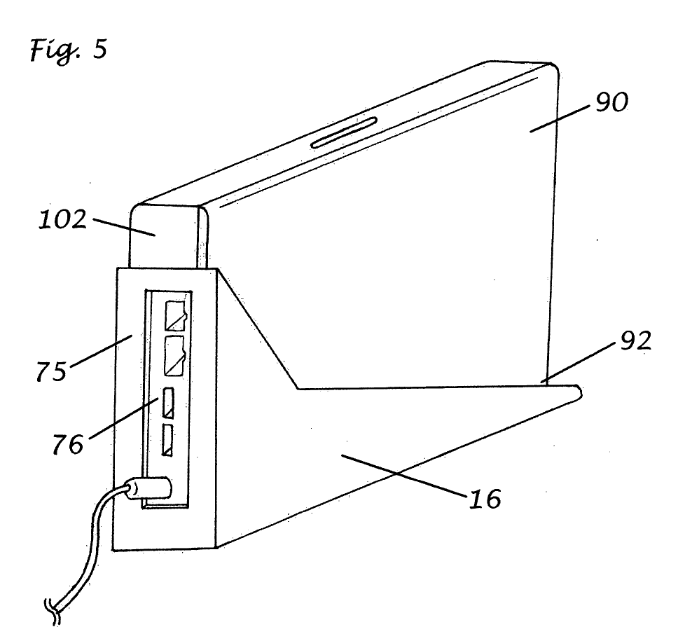

FIG. 5 offers a perspective of a variation of the embodiment shown in FIG. 1a where one device (16) supports the edge/spine (92) and one side of the laptop (102) to support it in the vertical orientation and thereby reduce its footprint on the desk. One vertical side of the device (75) has an opening (76) that permits the necessary power and interface cables to be connected to the laptop (90) while it is held within the device (16).

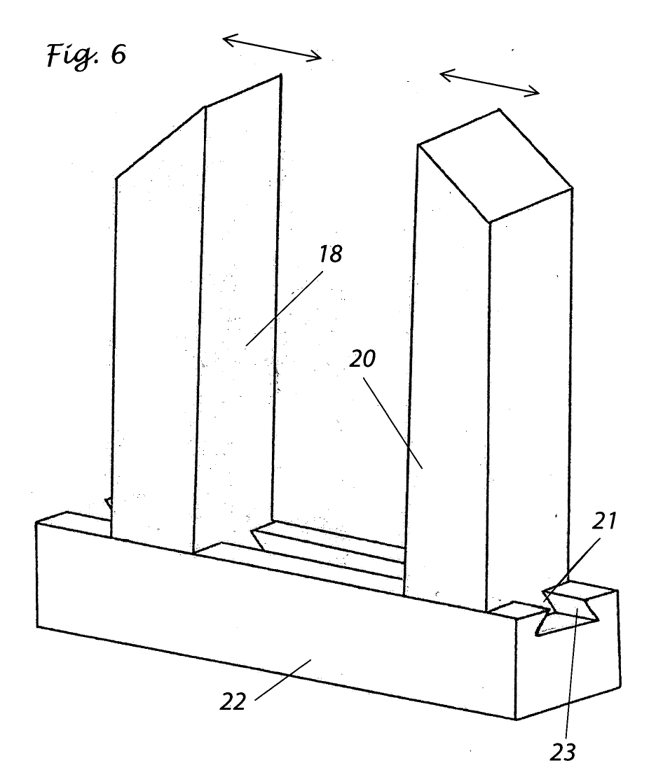

In FIG. 6, an alternate embodiment of the invention comprises a support base 22 with a tapered recessed track 23 in the top surface and two vertical supports 18 and 20 each having mating tapered bottoms 21 to slide in the track 23 to adjust the vertical supports horizontally, as shown by the double arrows to retain portable computers of a variety of thicknesses.

The preferred embodiment and its variations can also be colored using various currently available manufacturing techniques or made from materials that match the colors of specific laptop brands to increase consumer desirability, e.g., black (IBM) or white/clear (Apple Computer).

It is understood that the preceding description is given merely by way of illustration and not in limitation of the invention and that various modifications may be made thereto without departing from the spirit of the invention as claimed.

What is claimed is:

1. A portable computer upright support device that supports a portable computer in a vertical orientation on the users work area to reduce the footprint of the portable computer and increase the usable desk space with the portable computer being directly connected to external user input and output devices by hardwiring or using wireless technologies to an external monitor, full size keyboard and mouse, the device comprising:
at least one support base wider than a thickness of a portable computer to be supported vertically, the at least one support base having a horizontal bottom surface for resting on an external horizontal surface and an upper horizontal surface for receiving a side edge of the portable computer resting thereon;
at least two vertical supports connected to the at least one support base, the at least two vertical supports spaced apart by at least the thickness of the portable computer to be supported vertically, the at least two vertical supports each having an interior face for contacting a top or bottom surface of the portable computer, the at least two vertical supports having a sufficient height for maintaining the portable computer in an upright position with a top and bottom surface of the portable computer both in a substantially vertical orientation and the at least two vertical supports in combination with the at least one support base having a sufficient breadth to maintain the portable computer in an upright position without tipping over, the at least two vertical supports having an opening therebetween to admit cable connections or wireless signals from the portable computer to communicate with an adjacent full size monitor, full size keyboard, and mouse.

2. The device of claim 1 wherein the at least one support base and the at least two vertical supports are fabricated by at least one of the fabrication methods taken from the list of fabrication methods including casting (full mold/evaporative pattern casting, gravity die casting, pressure die casting, squeeze casting, investment casting or sand casting), molding (injection molding, compression molding or vacuum molding), forging, machining (conventional and/or electrical discharge machining (a.k.a. EDM), water jet cutting, Computerized Numerical Control (a.k.a. CNC), laser cutting, lathe, or milling), spray forming and/or powder processing (pressing and sintering metallic or polymeric powder).

3. The device of claim 1 wherein the at least one support base and the at least two vertical supports are fabricated from at least one material taken from the list of materials including metallic (aluminum or aluminum alloys, iron or iron-based alloys, titanium or titanium alloys, copper or copper alloys, nickel or nickel alloys, tin or tin alloys or other metallic materials), plastic (ABS, acrylic, PVC, Bakelite, nylon, Acetal Delrin, polycarbonate, polyester, polyethylene (HDPE, LDPE, UHMW), polypropylene or polyurethane), polymers (fluoropolymers or rubber) nanomaterials, composites (fiberglass reinforced plastic or carbon fiber), carbon-based materials (graphite), ceramics (high-alumina ceramic), glass (Borosilicate glass (Pyrex/Schott)) or wood.

4. The device of claim 1 wherein the at least one support base and the at least two vertical supports are colored or are fabricated from colored materials to match brand preferences to increase consumer desirability.

5. The device of claim 1 wherein the at least one support base and the at least two vertical supports are fabricated in a simple structure easily and inexpensively manufactured in a compact shape easily transported, shipped, and stored requiring no built-in electronics that must act as an interface between the laptop and peripheral user input and output devices.

6. The device of claim 1 wherein the at least two vertical supports comprise two brackets each with a pair of spaced vertical supports positioned along the spine edge of the laptop computer to support it in a vertical orientation and the at least one support base comprises a rigid structure interconnecting the two brackets.

7. The device of claim 6 wherein the rigid structure comprises at least two rods.

8. The device of claim 6 wherein the rigid structure comprises a plate.

9. The device of claim 1 wherein the at least two vertical supports comprise a single bracket formed with two spaced vertical walls forming the at least two vertical supports that is positioned at a central location along the spine edge of the portable computer and the at least one support base comprises a bottom of the single bracket.

10. The device of claim 9 further comprising a fan built into at least one of the vertical walls, the fan being powered by at least one source of power taken from the list of power sources including an internal Universal Serial Bus (USB) of the portable computer, batteries, an AC adapter connected to an external power supply, and a standard electrical plug connected to an external power supply, the fan supplying additional cooling to the portable computer while held in the vertical orientation.

11. The device of claim 9 wherein at least one wall has a series of cooling ridges spaced along the at least one wall with air spaces between the cooling ridges to protect the portable computer from overheating.

12. The device of claim 1 wherein the at least two vertical supports comprise a bracket with a pair of spaced vertical walls at each end of the portable computer, the vertical walls interconnected by a vertical end wall and the at least one support base comprises a bottom surface of each of the brackets interconnecting the two spaced vertical walls to support opposing corners of the portable computer to orient it vertically.

13. The device of claim 1 wherein the at least two vertical supports comprise two spaced walls covering the top and bottom surfaces of the portable computer, the at least one support base comprises an elongated bottom interconnecting surface between the two spaced walls and further comprising a top elongated surface interconnecting the two spaced walls along two top edges of the two spaced walls to form an envelope encasing the top and bottom and two opposing edges of the portable computer with a vertical opening between the two spaced walls on at least one end to admit the portable computer inserted therethrough.

14. The device of claim 13 comprising at least one opening on at least one end of the two spaced wall to access a CD-ROM device in the portable computer.

15. The device of claim 13 further comprising a fan built into at least one of the two spaced vertical walls, the fan being powered by at least one source of power taken from the list of power sources including an internal Universal Serial Bus (USB) of the portable computer, batteries, an AC adapter connected to an external power supply, and a standard electrical plug connected to an external power supply, the fan supplying additional cooling to the portable computer while held in the vertical orientation.

16. The device of claim 13 wherein at least one of the two spaced walls has a series of cooling ridges spaced along the at least one wall with air spaces between the cooling ridges to protect the portable computer from overheating.

17. The device of claim 1 wherein the at least two vertical supports comprise a corner support having a pair of spaced walls and the at least one support base comprises a bottom surface interconnecting the pair of spaced walls and further comprising a vertical end wall between the pair of spaced walls, the vertical end wall having an opening therein to admit necessary power and interface cables therethrough from peripheral devices to be connected to the portable computer while it is held within the device.

18. The device of claim 1 wherein the at least two vertical supports comprise a pair of vertical supports with at least one of the pair horizontally movable relative to the other to adjust the spacing therebetween for portable computers of a variety of thicknesses to fit therebetween.

19. The device of claim 1 wherein the at least one support base comprises a single support base having a horizontal track in a top surface and at least one of the pair of vertical supports has a bottom end to ride in the track and move along the length of the track.
